(19) United States
(12) Patent Application Publication
(10) Pub. No.: US 2015/0355115 A1
(43) Pub. Date: Dec. 10, 2015

(54) Calibrating an X-Ray Based Multiphase Flow Meter

(71) Applicants: Daria MUSTAFINA, Den Haag (NL); Stepan POLIKHOV, Ramenskoye (RU); Reiner Franz SCHULZ, Erlangen (DE)

(72) Inventors: Daria MUSTAFINA, Den Haag (NL); Stepan POLIKHOV, Ramenskoye (RU); Reiner Franz SCHULZ, Erlangen (DE)

(21) Appl. No.: 14/397,181

(22) PCT Filed: Apr. 25, 2012
(86) PCT No.: PCT/RU2012/000317

§ 371 Date: Jul. 27, 2015

(51) Int. Cl. G01N 23/12; G01F 1/76

(52) U.S. Cl. CPC G01N 23/12; G01F 1/76

(57) ABSTRACT

A device for determining a mass flow rate of a multiphase fluid within a pipe includes an X-ray source for providing X-rays at at least 2 different wavelengths and a corresponding X-ray detector arranged such that a detection section of the pipe is placed within the optical path of the X-rays between the X-ray source and the X-ray detector. A calibration chamber is located parallel to the detection section within the optical path of the X-rays.

This application is the National Stage of International Application No. PCT/RU2012/000317, filed Apr. 25, 2012. The entire contents of this document are hereby incorporated herein by reference.

### BACKGROUND

The present embodiments relate to a device for calibrating an X-ray based multiphase flow meter and a method for calibrating an X-ray based multiphase flow meter.

To determine the volumetric flow rate of a fluid through a pipe, Venturi tubes may be employed. Such a flow meter includes a constriction within the pipe, which leads to a decrease of fluid pressure in the constricted part. The pressure differential between the constricted and open part is directly dependent on the volumetric flow rate. For well-defined fluids of known density, the mass flow rate may be immediately derived from the volumetric flow rate.

In many technical applications (e.g., in petroleum and natural gas production), mass flow rates of ill-defined multiphase fluid mixtures (e.g., mixtures of natural gas and condensates or mixtures of crude oil, natural gas and water) are to be determined. Since the density of such mixtures is not known and may fluctuate on short timescales as a function of mixture composition, a straightforward derivation of mass flow rates from measured volumetric flow rates is not possible.

In such cases, the density of composition of the fluid and a volumetric flow rate of the fluid are to be measured to accurately determine mass flow. This may be accomplished by X-ray absorption, since, for example, crude oil, natural gas and water have significantly different X-ray absorption spectra. Measuring the absorption of X-rays at at least two different wavelengths may therefore be used to quantify fluid composition and thereby density. A multiphase flow meter of this type is described in EP 1 286 140 B1.

To reach the desired accuracy of measurement, such devices are to be calibrated in regular intervals. This may be done manually, which is a labor intensive process and may result in disruptions of the fluid flow. For these reasons, manual calibration incurs high costs.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a device and a method that allow for a fast and non-disruptive calibration of X-ray based flow meters are provided.

Such a device for determining a mass flow rate of a multiphase fluid within a pipe includes an X-ray source for providing X-rays at at least 2 different wavelengths and a corresponding X-ray detector arranged such that a detection section of the pipe is placed within the optical or projection path of the X-rays between the X-ray source and the X-ray detector.

According to one or more of the present embodiments, a calibration chamber is located parallel to the detection section within the optical path of the X-rays.

This placement of the calibration chamber allows for easy on-line calibration of the device without interruption in the flow rate measurements.

The calibration chamber may be connected to the pipe via a first duct opening into an aperture of the pipe wall and a second duct opening into a sampling probe within the an inner volume of the pipe. The first duct includes a first shut-off valve, and the second duct includes a second shut-off valve.

Opening the first shut-off valve while the second shut-off valve is closed allows gas exchange between the pipe and the sample calibration chamber, while no significant amount of liquids is transferred from the pipe to the chamber. After an equilibration period, the calibration chamber is therefore filled with the gaseous fraction of the multiphase fluid, allowing for an easy calibration of the detector with regard to the X-ray absorption coefficient of the gaseous fraction.

To collect the liquid fraction of the multiphase fluid, the first and second valve are both opened. The liquid fraction is collected by the sampling probe and streams into the calibration chamber via the second duct. Gas still contained within the chamber is replaced by the liquid fraction and flows back into the pipe via the first duct. As soon as the chamber is filled, the device may be calibrated with regard to the X-ray absorption coefficient of the pure liquid phase. In case of multiphase fluids with multiple unmixable liquid phases (e.g., oil-water-mixtures), the liquid phases may be separated by gravitational settling, so that the device may be separately calibrated with regard to all liquid phases present.

To achieve the desired separation, the opening of the second duct into the calibration chamber may be located above the opening of the first duct.

To purge the sample chamber, the sample chamber may be connected to the pipe by a third duct that opens into a Venturi section of the pipe and may be closed by a third shut-off valve. The lower static pressure in the Venturi section creates suction towards the third duct. Purging is accomplished by opening the first and third shutoff-valves, thereby replacing all liquid contents of the chamber by the gaseous fraction. To provide complete removal of the liquid phase from the chamber, the third duct may open into the bottom part of the chamber.

Connecting the chamber to the atmospheric environment via a fourth shutoff-valve within the second duct allows for another measurement. If the fourth shut-off valve is opened while the chamber is filled with liquid, the pressure drop will cause unstable condensates to evaporate, making it possible to determine the ratio of stable to unstable condensates in the liquid phase.

In order to acquire meaningful calibration results, the calibration chamber may have the same cross-sectional shape and/or the same wall thickness as the detection section of the pipe.

One or more of the present embodiments relate to a method for measuring a mass flow rate of a multiphase fluid. To determine the phase composition, the X-ray absorption of the fluid is measured, so that the composition may be calculated from known absorption coefficients of the pure phases. In order to calibrate such a flow meter, according to one or more of the present embodiments, a portion of the fluid is diverted to a calibration chamber located within the X-ray optical path such that at least one pure phase is accumulated within the sample chamber. Subsequently, the X-ray absorption of the pure phase is measured for calibration purposes.

This allows for a quick, on-line determination and correction of measurement accuracy, as detailed above. The process may be automated and performed in regular intervals, so that no intervention is necessary to provide a constant quality of flow measurements.

To determine the X-ray absorption of the pure gaseous phase of the multiphase liquid within the scope of one or more of the present embodiments, the calibration chamber is connected to the pipe via a first duct opening into an aperture of the wall of the pipe. This allows for diffusion of the gaseous phase into the chamber without any sampling of the liquid phase.

The liquid phase may be collected in the calibration chamber by connecting the chamber to a sampling probe located within the inner volume of the pipe. The sampling probe diverts part of the flow to the sampling chamber, where the liquid phase is retained, while the gaseous phase may flow back to the pipe via the first duct. After filling the calibration chamber, X-ray absorption of the pure liquid phase may be determined.

In case of the presence of multiple mutually insoluble liquid phases, such as in an oil-water-gas-mixture, the liquid phases may be separated within the calibration chamber by gravitational settling. Subsequently, the X-ray absorption of the liquid phases may be determined independently (e.g., by using a matrix-type X-ray detector).

If the calibration chamber is connected to the surrounding atmosphere while filled with liquid, volatile components of the liquid evaporate. This may be used to determine the ration of stable and unstable condensates in the liquid phase.

After determining the X-ray absorption of the at least one liquid phase, the calibration chamber may be purged by connecting calibration chamber to a Venturi part of the pipe, so that the liquid is sucked back into the pipe due to the lower static pressure of the Venturi part.

### BRIEF DESCRIPTION OF THE DRAWINGS

FIG. 1 shows a front view of an embodiment of a device;

FIG. 2 shows a top view of an embodiment of a device;

FIG. 3 shows a left side view of an embodiment of a device;

FIG. 4 shows a right side view of an embodiment of a device;

FIG. 5 shows thermal insulation of one embodiment of a calibration chamber; and

FIG. 6 shows an alternative design for thermally coupling the calibration chamber to a pipe.

### DETAILED DESCRIPTION

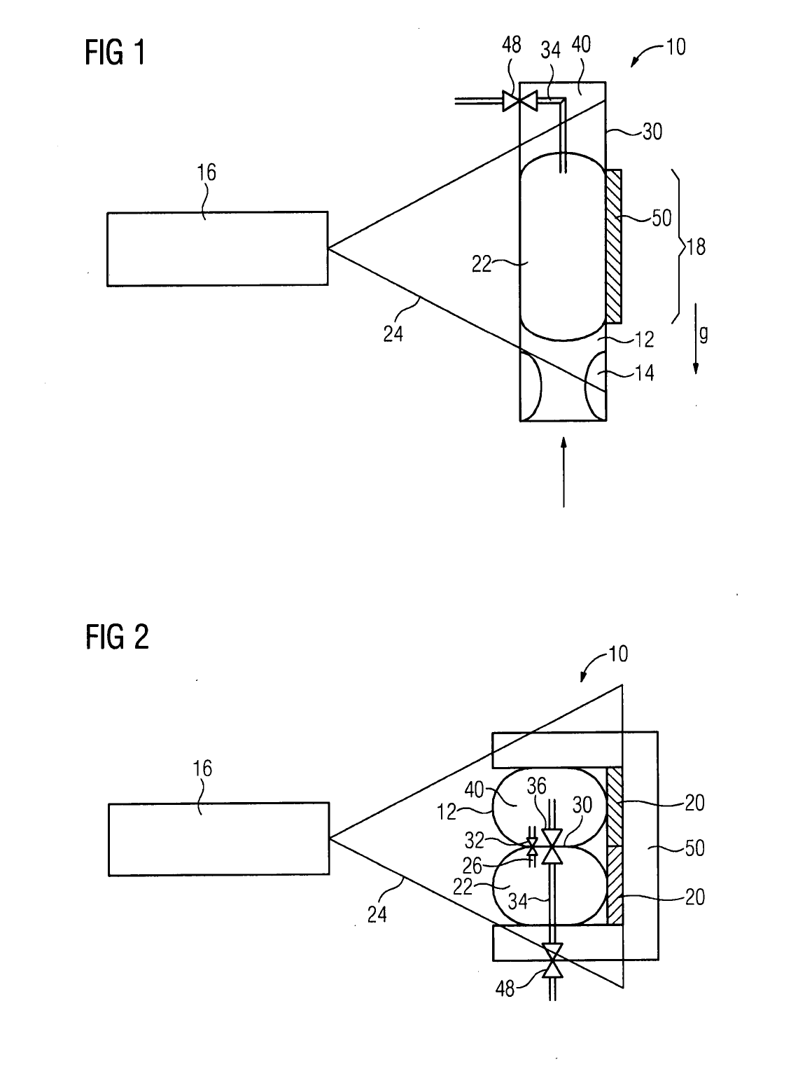

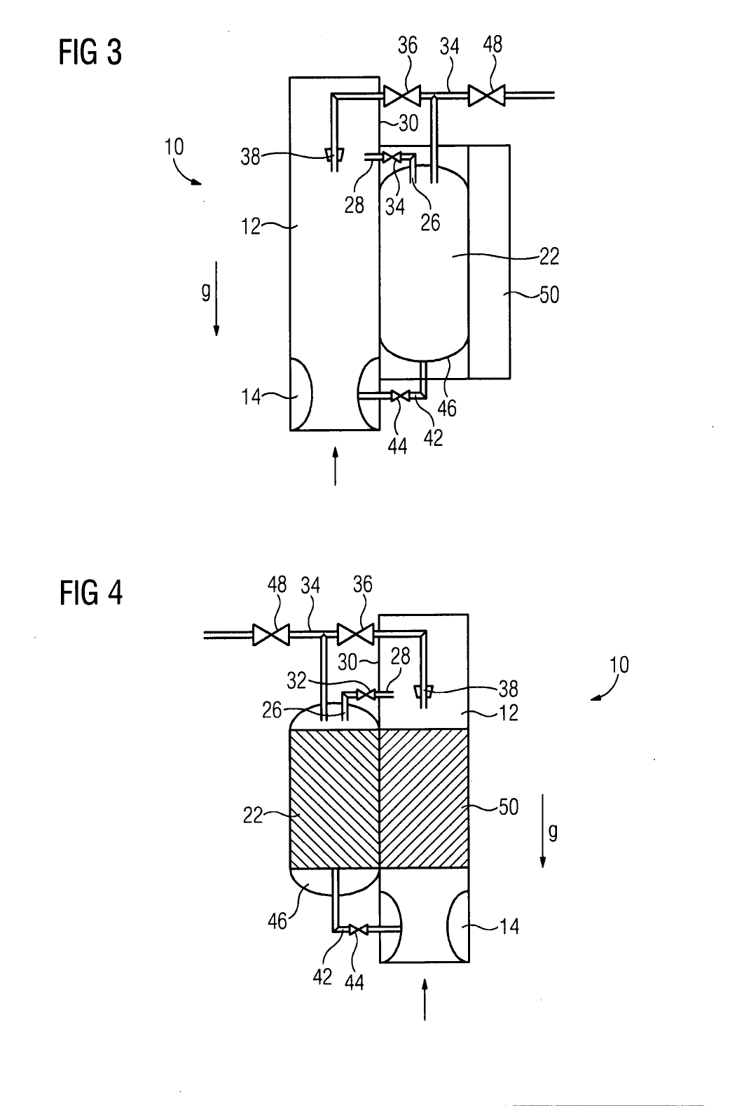

A device 10 to determine a mass flow of a multiphase fluid within a pipe 12 is provided, as shown in FIGS. 1-4. A volumetric flow is determined by a constriction 14 in the pipe 12 acting as a Venturi device. By measuring a difference in static pressure between a constricted part 14 and an unconstructed part of the pipe 12, flow speed may be determined.

In order to calculate the mass flow from the volumetric flow, a density of the multiphase fluid is determined. For known densities of the individual phases, this may be achieved by measuring the phase composition of the fluid. Since in many applications (e.g., for crude oil/water/natural gas—mixtures) the X-ray absorption coefficients of the individual phases differ strongly, X-ray spectroscopy is a straightforward method to achieve this goal.

An X-ray source 16 provides X-rays at at least two different energies. The X-rays permeate a detection section 18 of the pipe 12 and are detected by a corresponding X-ray detector 20 located opposite to the X-ray source 16.

To provide a constant and high accuracy of measurements, the device 10 is to be calibrated in regular intervals. This is best achieved by measuring the X-ray absorption of pure phases of the multiphase mixture. For this purpose, a calibration chamber 22 is located parallel to the pipe 12 within the optical path 24 of the X-rays.

The calibration chamber 22 is connected to the pipe 12 by a first duct 26 opening into an aperture 28 of the pipe wall 30. The first duct may be closed by a first shut-off valve 32.

A second duct 34 with a second shutoff-valve 36 connects the calibration chamber 22 to a sampling probe 38 within the inner volume 40 of the pipe 12.

A third duct 42 with a third shut-off valve 44 further connects the bottom part 46 of the calibration chamber with the constricted section 14 of the pipe 12.

The second duct 34 is connectable to the surrounding atmosphere via a fourth shut-off valve 48.

To calibrate the device 10 when used for measuring the flow of a natural gas/condensate mixture, the first shut-off valve 32 is opened, while all other valves 36, 44, 48 stay closed. This allows for diffusion of the gaseous phase into the calibration chamber 22. After a certain amount of time, the chamber 22 is completely filled with the gaseous phase of the multiphase fluid, so that an X-ray absorption of the multiphase fluid may be measured via the detector 20.

After the measurement is performed, shut-off valve 36 is opened. A liquid portion of the multiphase flow is collected via the sampling probe 38. Liquid entering the calibration chamber 22 forces the gaseous phase out via the first duct 26, so that the condensates accumulate within the calibration chamber 22 and may be analyzed by the X-ray detector 20.

In order to determine the ratio between stable and unstable condensates, the pressure within the calibration chamber 22 may be lowered by opening shut-off valve 48 and closing all other valves 32, 36, 44. The pressure drop causes the unstable condensates to evaporate so that only the stable condensates remain and may be spectroscopically analyzed.

The fourth shut-off valve 48 is closed, and the second and third shut-off valves 32, 44 are opened. The pressure differential between the aperture 28 and the constricted part 14 of the pipe 12 causes the liquid to be expelled from the chamber 22 via the third duct 42. The device is now ready to commence normal measurements and/or for another calibration run.

In case of fluids with multiple liquid phases (e.g., crude oil/natural gas/water—mixtures), the calibration process is slightly different.

In a first act, the calibration chamber 22 is filled with a sample of the fluid flowing through the pipe 12. To achieve this, shut-off valves 36 and 44 are opened, while valves 32 and 48 stay closed. Due to the pressure differential between the sampling probe 38 and the constricted part 14 of the pipe 12, a mixture of all phases of the fluid is sucked into the calibration chamber 22. Since the second duct 34 is connected to a top part of the calibration chamber, and the third duct is connected to a bottom part of the calibration chamber, the gas content of the mixture in the calibration chamber 22 will be somewhat higher than the actual gas content in the multiphase fluid.

After filling the calibration chamber 22, valves 36 and 34 are closed, and valve 32 is opened. During this phase, gravitational stratification of the multiphase mixture within the calibration chamber 22 occurs. The water phase collects at the bottom of chamber 22, followed by the oil and the gas phase.

If a matrix sensor 22 is used, the X-ray absorption for all three phases may be measured simultaneously, thereby achieving the desired calibration.

To provide meaningful calibration data, the calibration chamber 22 and contents of the calibration chamber 22 are to be held at approximately the same temperature as the multiphase fluid within the pipe 12. The detection section 18 and the calibration chamber 22 are therefore encased in a thermal insulation 50.

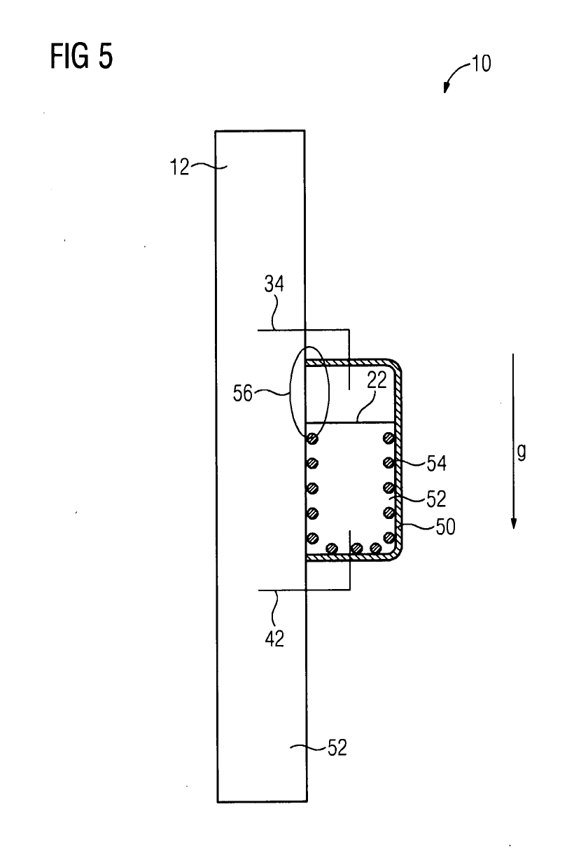

As shown in FIG. 5, thermal sensors are in thermal contact with the pipe 12 and the calibration chamber 22 at multiple points 52. In case of a temperature difference, which would not only hamper the accuracy of calibration but also be conducive to precipitation of wax from the liquid phase, the calibration chamber 22 may be heated by heating elements 54. Further, heat transfer between the pipe 12 and the calibration chamber 22 is facilitated by a direct thermal contact 56.

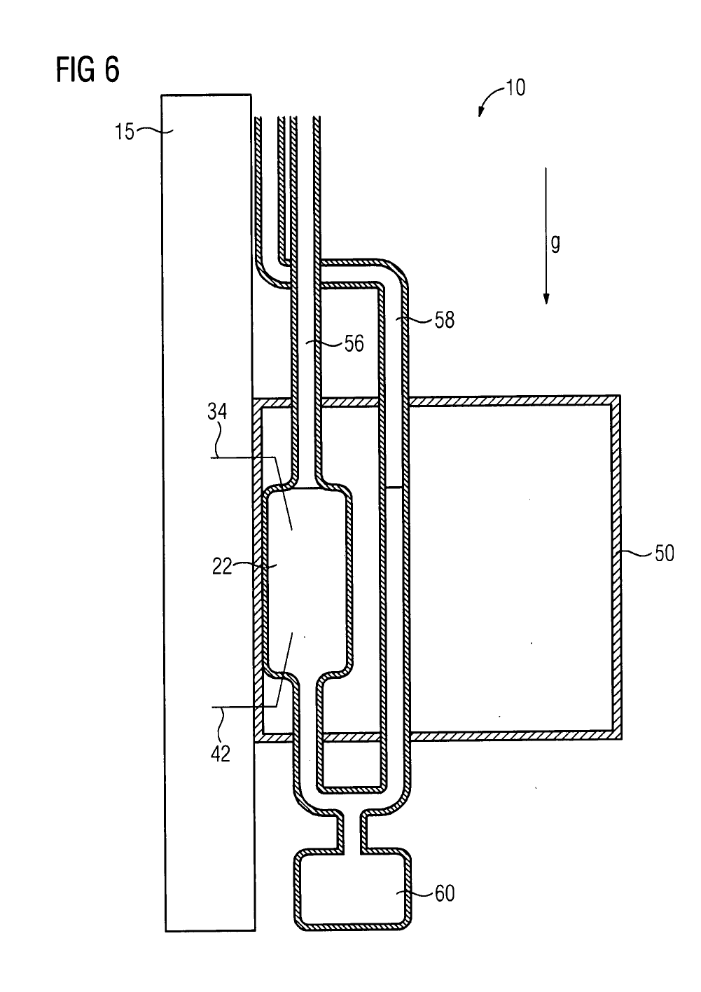

FIG. 6 shows an alternative design for providing thermal equilibrium between the fluid in the pipe 12 and the calibration chamber 22. In this embodiment, the wall of the calibration chamber 22 is thermally isolated from the pipe 12 by the thermal insulation 50. Equilibration of temperature is reached by connecting the top and bottom portions of the calibration chamber 22 by a duct loop 58 including a thermal contact portion 56.

After completely filling the calibration chamber 22, a piston 60 is retracted, thereby increasing the volume of the calibration chamber 22, which leads to evaporation of a small amount of hydrocarbons. The saturated vapor condenses in the thermal contact portion and flows back to the bottom part of the calibration vessel 22 at about the temperature of the fluid in pipe 12. Additional heating may be applied to prevent wax precipitation.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A device for determining a mass flow rate of a multiphase fluid within a pipe, the device comprising:
an X-ray source operable to provide X-rays at at least 2 different wavelengths;
an X-ray detector arranged such that a detection section of the pipe his placed within an optical path of the X-rays between the X-ray source and the X-ray detector; and
a calibration chamber located parallel to the detection section within the optical path of the X-rays.

2. The device of claim 1, wherein the calibration chamber his connected to the pipe via a first duct opening into an aperture of a pipe wall and comprising a first shut-off valve, and via a second duct opening into a sampling probe within an inner volume of the pipe and comprising a second shut-off valve.

3. The device of claim 2, wherein the first duct opens into the calibration chamber vertically below the second duct.

4. The device of claim 2, wherein the calibration chamber is connected to the pipe via a third duct comprising a third shut-off valve.

5. The device of claim 4, wherein the third duct connects a bottom part of the calibration chamber with a Venturi portion of the pipe.

6. The device of claim 4, wherein the second duct is connectable to the outside atmosphere via a fourth shut-off valve.

7. The device of claim 1, wherein the calibration chamber has a same cross-section, wall thickness, or cross-section and wall thickness as the detection section.

8. A method for determining a mass flow rate of a multiphase fluid within a pipe, the method comprising:
providing X-rays at at least 2 different wavelengths;
passing the X-rays through a detection section of the pipe;
measuring X-ray absorption within the detection section using a corresponding X-ray detector, followed by calculating a phase composition of the multiphase fluid based on the measured X-ray absorption; and
for calibration purposes, diverting a portion of the multiphase fluid into a calibration chamber located within the optical path of the X-rays and phase-separating the portion of the multiphase fluid within the calibration chamber so that an X-ray absorption of at least one phase of the multiphase fluid is determinable.

9. The method of claim 8, further comprising diverting a portion of the gaseous phase of the multiphase fluid to the calibration chamber, the diverting comprising connecting the calibration chamber to the pipe via a first duct opening into an aperture of a pipe wall.

10. The method of claim 8, further comprising diverting a portion of at least one liquid phase of the multiphase fluid to the calibration chamber using a sampling probe located within an inner volume of the pipe.

11. The method of claim 10, further comprising separating liquid phases within the calibration chamber when the multiphase fluid includes multiple liquid phases, the separating comprising gravitational settling.

12. The method of claim 10, further comprising separating volatile components of the at least one liquid phase from stable components, the separating comprising connecting the calibration chamber to the surrounding atmosphere and evaporating the volatile components.

13. The method of claim 10, further comprising purging the at least one liquid phase from the calibration chamber after measuring the X-ray absorption of the at least one liquid phase, the purging comprising connecting the calibration chamber to a Venturi part of the pipe.

14. The method of claim 9, further comprising diverting a portion of at least one liquid phase of the multiphase fluid to the calibration chamber using a sampling probe located within an inner volume of the pipe.

15. The method of claim 14, further comprising separating liquid phases within the calibration chamber when the multiphase fluid includes multiple liquid phases, the separating comprising gravitational settling.

16. The method of claim 11, further comprising separating volatile components of the at least one liquid phase from stable components, the separating comprising connecting the calibration chamber to the surrounding atmosphere and evaporating the volatile components.

17. The method of claim 11, further comprising purging the at least one liquid phase from the calibration chamber after measuring the X-ray absorption of the at least one liquid phase, the purging comprising connecting the calibration chamber to a Venturi part of the pipe.

18. The method of claim 12, further comprising purging the at least one liquid phase from the calibration chamber after measuring the X-ray absorption of the at least one liquid phase, the purging comprising connecting the calibration chamber to a Venturi part of the pipe.

19. The method of claim 8, wherein phase-separating comprises phase separating the portion of the multiphase fluid within the calibration chamber so that the X-ray absorption of at least one pure phase of the multiphase fluid is determinable.
